(19) United States
(12) Patent Application Publication
(10) Pub. No.: US 2013/0084048 A1
(43) Pub. Date: Apr. 4, 2013

(54) MULTI-MODE OPTICAL FIBER

(71) Applicants: Itaru SAKABE, Yokohama-shi (JP); Kazuyuki Soma, Yokohama-shi (JP); Tomoyuki Hattori, Yokohama-shi (JP)

(72) Inventors: Itaru SAKABE, Yokohama-shi (JP); Kazuyuki Soma, Yokohama-shi (JP); Tomoyuki Hattori, Yokohama-shi (JP)

(73) Assignee: SUMITOMO ELECTRIC INDUSTRIES, LTD., Osaka-shi (JP)

(21) Appl. No.: 13/248,313

(22) Filed: Sep. 29, 2011

(51) Int. Cl. G02B 6/028

(52) U.S. Cl. 385/124

(57) ABSTRACT

The present invention relates to a multi-mode optical fiber having a structure to reduce the numerical aperture at the emission end of the multi-mode optical fiber having a length for which practical use is assumed. The multi-mode optical fiber comprises a core portion, a trench portion, and a cladding portion. The multi-mode optical fiber is designed such that the numerical aperture at the emission end thereof is reduced as the fiber length increases, and moreover such that the numerical aperture of the multi-mode optical fiber having a length for which practical use is assumed satisfies a specific condition. By this means, the numerical aperture at the emission end of the multi-mode optical fiber can be kept small, and coupling efficiency of the multi-mode optical fiber with other optical components is drastically improved.

### BACKGROUND OF THE INVENTION

1. Field of the Invention

The present invention relates to a multi-mode optical fiber.

2. Related Background Art

Structures in which a trench portion is provided on the periphery of the core portion are known in the prior art as a method of reducing bending losses in single-mode optical fibers. A trench portion brings about an improvement in the light confinement effect. As a result, light leakage does not readily occur when the single-mode optical fiber is bent.

On the other hand, a multi-mode optical fiber is a light transmission medium in which a plurality of propagation modes exist, differing from a single-mode optical fiber, and thus is clearly distinguished from single-mode optical fibers with respect to both structure and fields of application. However, similarly to single-mode optical fibers, by providing a trench portion on the periphery of the core portion of a multi-mode optical fiber also, the effective refractive index is raised, and the confinement effect for light of each mode is heightened. Hence in multi-mode optical fibers also, leakage of light upon bending is reduced due to the existence of a trench portion.

### SUMMARY OF THE INVENTION

The present inventors have examined the above prior art, and as a result, have discovered the following problems.

Because a trench portion has the effect of raising the effective refractive index, when applied to a multi-mode optical fiber, there is an effect of reducing bending losses. On the other hand, there is a characteristic that compared with a general-use multi-mode optical fiber without a trench portion, in the case of a multimode fiber provided with a trench portion, the numerical aperture (NA) representing the light incidence angle and emission angle is increased. Hence for a multi-mode optical fiber with a large numerical aperture, light emitted from a light source with a large incidence angle can also be confined inside, so that the coupling efficiency on the light source side is improved. On the other hand, with respect to coupling with a light receiver, there is the problem that the coupling efficiency is reduced when compared to a general-use multi-mode optical fiber. This is because the angle of radiation of light generated from the fiber end face is large.

The present invention has been developed to eliminate the problems described above. It is an object of the present invention to provide a multi-mode optical fiber having a structure such that, by reducing the numerical aperture of the emission end of the multi-mode optical fiber having a length for which practical use is assumed, the coupling ratio with other optical components is drastically improved.

The present invention is related to a GI (Graded Index) type multi-mode optical fiber; such multi-mode optical fibers are structurally clearly differentiated from single-mode optical fibers for use in long-haul transmission.

That is, a multi-mode optical fiber according to the present invention comprises a core portion extending along a predetermined axis and doped with GeO₂ (germanium dioxide); a trench portion provided on an outer periphery of the core portion and having a refractive index lower than that of the core portion; and a cladding portion provided on an outer periphery of the trench portion and having a refractive index lower than that of the core portion but higher than that of the trench portion. In a refractive index profile of the multi-mode optical fiber along a radial direction thereof, the a value of the portion corresponding to the core portion is 1.9 to 2.2, the relative refractive index difference Δ of the core portion center (maximum relative refractive index difference of the core portion) with respect to the cladding portion is 0.8 to 1.2%, and the diameter 2a of the core portion is 47.5 to 52.5 μm. The difference between the maximum relative refractive index difference of the core portion and the minimum relative refractive index difference of the trench portion, with respect to the cladding portion, is 1.6% or lower.

In the multi-mode optical fiber having the above-described structure, a graph representing a relation between a numerical aperture and a length has a shape in which an absolute value of the slope of the graph has a maximum at a length between 0.5 and 500 m. When the maximum refractive index of the core portion is n1, the minimum refractive index of the trench portion is n2, and the refractive index of the cladding portion is n3, then the numerical aperture NA(500 m) at length 500 m of the multi-mode optical fiber satisfies the following condition:

NA(500 m)≦\sqrt{n1²−n3²}.

It is known that in general, due to the structure, a multi-mode optical fiber has larger transmission losses than a single-mode optical fiber for long-haul optical communication. On the other hand, connection because fiber-to-fiber connections are easy, such fibers are widely used in LANs (Local Area Networks) and other short-haul information communication applications. For example, the length of a multi-mode optical fiber required for connection of equipments installed within a building is at most approximately 500 m. Hence, in the present invention, the numerical aperture at a measurement length of 500 m, NA(500 m), is defined as a parameter representing the numerical aperture on the light emission end.

In a multi-mode optical fiber according to the present invention, it is preferable that the refractive index of the trench portion increase from the core portion toward the cladding portion along the radial direction of the multi-mode optical fiber. In this case, the effect of reduction of the numerical aperture of the multi-mode optical fiber at the emission end, compared with a structure in which a trench portion is simply provided, is prominent.

In a multi-mode optical fiber according to the present invention, a planar portion of width 0 to 10 μm (a portion in which the refractive index is substantially the same in the radial direction) may be provided between the core portion and the trench portion. In this case, a sufficient light confinement effect can be anticipated even when the absolute value of the minimum relative refractive index difference of the trench portion with respect to the cladding portion is reduced.

Further, in a multi-mode optical fiber according to the present invention, the width of the trench portion is 10 μm or less, and preferably 5 μm or less.

In a multi-mode optical fiber according to the present invention, it is preferable that the numerical aperture at length 0.5 m, NA(0.5 m), of the multi-mode optical fiber satisfy the following condition:

\sqrt{n1²−n3²}≦NA(2 m)≦\sqrt{n1²−n2²}.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the scope of the invention will be apparent to those skilled in the art from this detailed description.

### BRIEF DESCRIPTION OF THE DRAWINGS

FIG. 1A shows a representative cross-sectional view of a multi-mode optical fiber according to the present invention; and FIG. 1B shows, in enlargement in the radial direction, the refractive index profile in FIG. 1A;

FIG. 2 is a graph showing the relation between measurement length and numerical aperture in a multi-mode optical fiber according to the present invention;

FIG. 3A shows in detail a portion corresponding to the vicinity of the trench portion in the refractive index profile shown in FIG. 1B; and FIG. 3B shows in detail a portion corresponding to the vicinity of the trench portion in the refractive index profile of a modified example of a refractive index profile which can be applied to a multi-mode optical fiber according to the present invention;

FIG. 4A shows the refractive index profile of the multi-mode optical fiber according to Embodiment 1, prepared for the purpose of measurement of the relation between measurement length and numerical aperture; FIG. 4B shows the refractive index profile of the multi-mode optical fiber according to Embodiment 2; and FIG. 4C shows the refractive index profile of the multi-mode optical fiber according to Embodiment 3; and

FIG. 5 is a graph showing measurement results for multi-mode optical fibers according to Embodiments 1 to 3, having the refractive index profiles shown in FIG. 4A to FIG. 4C.

### DESCRIPTION OF THE PREFERRED EMBODIMENTS

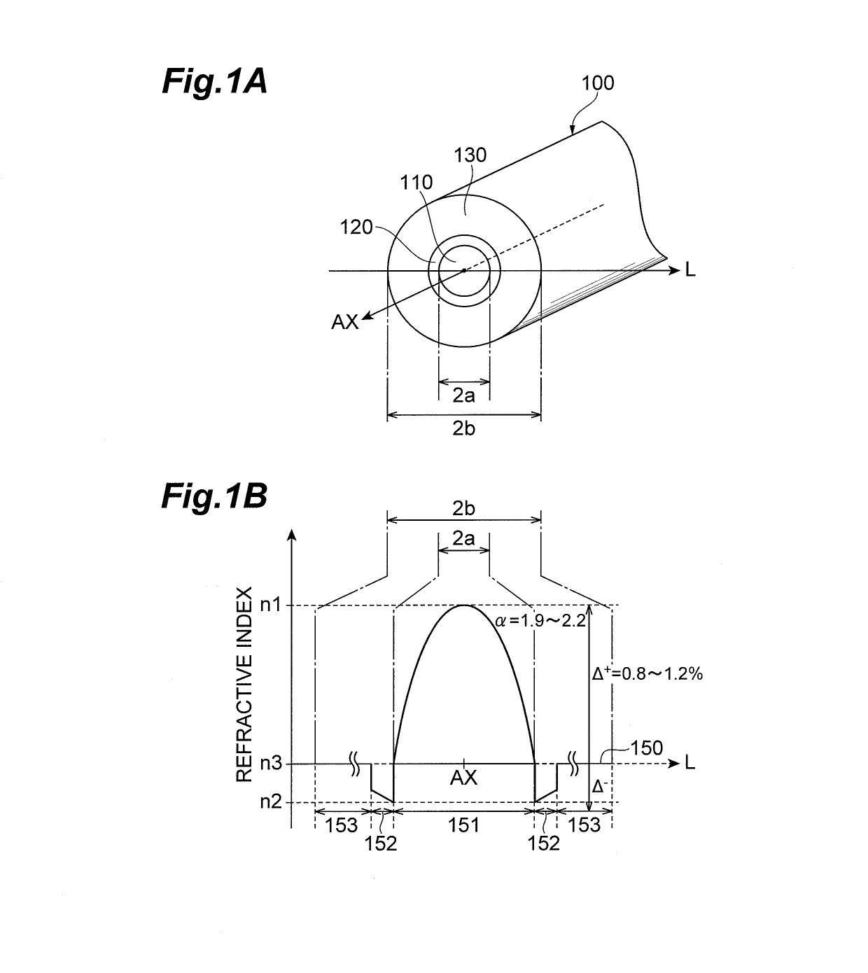

In the following, embodiments of a multi-mode optical fiber according to the present invention will be explained in detail with reference to FIGS. 1A to 1B, 2 to 3, 4A to 4C, and 5. In the description of the drawings, identical or corresponding components are designated by the same reference numerals, and overlapping description is omitted.

FIG. 1A shows the representative cross-sectional structure of a multi-mode optical fiber according to the present invention, and FIG. 1B shows the refractive index profile thereof. In particular, the multi-mode optical fiber 100 (FIG. 1A) according to the present embodiment is a GI-type multi-mode optical fiber mainly composed of silica glass, and comprises at least a core portion 110 extending along a predetermined axis (coinciding with the optical axis AX), a trench portion 120 provided on the outer periphery of the core portion 110, and a cladding portion 130 provided on the outer periphery of the trench portion 120. In the multi-mode optical fiber 100 shown in FIG. 1A, the core portion 100 is doped with GeO₂ to adjust the shape of the refractive index profile, and has a diameter 2a and a maximum refractive index n1. The trench portion 120 has a minimum refractive index n2 lower than that of the core portion 110. The cladding portion 130 has a diameter 2b and refractive index n3 lower than that of the core portion 110 but higher than that of the trench portion 120.

Further, the multi-mode optical fiber 100 according to the present embodiment has the refractive index profile 150 shown in FIG. 1B. The refractive index profile 150 shown in FIG. 1B has refractive indices at each position on the line L orthogonal to the optical axis AX in FIG. 1A (coinciding with the radial direction of the multi-mode optical fiber 100), and more specifically, the region 151 shows the refractive index at each position of the core portion 110 along the line L, the region 152 shows the refractive index at each position of the trench portion 120 along the line L, and the region 153 shows the refractive index at each position of the cladding portion 130 along the line L.

Specifically, the region 151 in the refractive index profile 150 of FIG. 1B is for the core portion 110 coinciding with the optical axis AX, and the refractive index is maximum at the center, having a so-called α-profile shape. Hence the concentration of the GeO₂ doped for refractive index adjustment also declines rapidly from the center of the core portion 110 toward the trench portion 120. The value of a which defines this α-profile shape is from 1.9 to 2.2. With respect to the cladding portion 130 (in the example of FIG. 1A, the region 153, which is a single layer; the entire region serves as a reference region defining the relative refractive index difference), the relative refractive index difference Δ⁺ of the center of the core portion 110 (the maximum refractive index difference of the core portion 110 with respect to the cladding portion 130) is 0.8 to 1.2%, and the diameter 2a of the core portion 110 is 47.5 to 52.5 μm. The minimum relative refractive index difference Δ⁻ of the trench portion 120 with respect to the cladding portion 130 is −0.4% or more, and adjustment is performed such that the difference between the maximum relative refractive index difference of the core portion 110 and the minimum relative refractive index difference of the trench portion 120 is 1.6% or less.

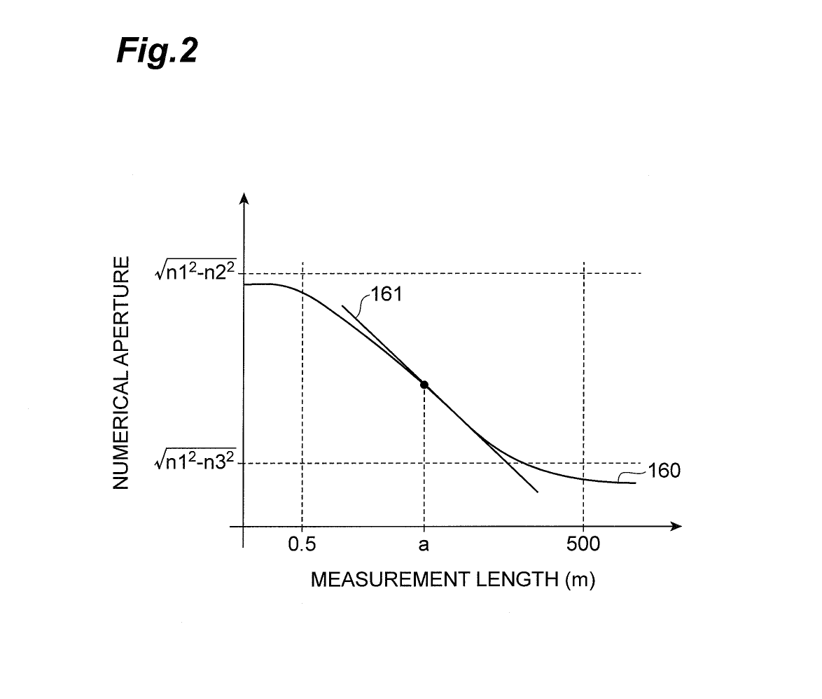

FIG. 2 is a graph showing the relation between measurement length and numerical aperture for a multi-mode optical fiber according to the present invention.

The graph 160 representing the relation between numerical aperture and length (hereafter called the measurement length for measuring numerical aperture) of the multi-mode optical fiber 100 has a shape such that the absolute value of the slope has a maximum at a measurement length between 0.5 and 500 m. That is, in the multi-mode optical fiber 100, the slope of the tangent 161 to the graph 160 is maximum at a measurement length a(m) existing in the range 0.5 m or greater and 500 m or less. In this way, the numerical aperture at the incidence end and the numerical aperture at the emission end can satisfy equations (2a) and (2b). Further, there are the advantageous results that the numerical aperture at the emission end of the multi-mode optical fiber 100 having a length for which practical use is assumed is kept small, and as a result, the coupling efficiency with a light receiver can be increased.

When the maximum refractive index of the core portion 110 is n1, the minimum refractive index of the trench portion 120 is n2, and the refractive index of the cladding portion 130 is n3, then the numerical aperture for the core-cladding structure is given by equation (1a) below, and the numerical aperture for the core-trench structure is given by equation (1b) below.

\sqrt{n1²−n3²} (1a)

\sqrt{n1²−n2²} (1b)

Hence in order to improve the coupling efficiency with a light receiver or similar, the numerical aperture NA(500 m), at the measurement length of 500 m for which practical use is assumed, of the multi-mode optical fiber 100 must satisfy the condition of equation (2a) below. On the other hand, in order to obtain sufficient coupling capacity with the light source, it is preferable that the numerical aperture NA(0.5 m) at the shorter measurement length 0.5 m of the multi-mode optical fiber 100 satisfy the following condition (2b):

NA(500 m)≦\sqrt{n1²−n3²} (2a)

\sqrt{n1²−n3²}≦NA(2 m)≦\sqrt{n1²−n2²} (2b).

In particular, as one example, a multi-mode optical fiber is considered in which the outer diameter of the core portion 110 is 50 μm, the a value defining the shape of the refractive index profile in the core portion 110 is 2, the maximum refractive index n1 of the core portion 110 is 1.4544 (at wavelength 633 nm), the minimum refractive index n2 of the trench portion 120 is 1.4324 (at wavelength 633 nm), the refractive index n3 of the cladding portion 130 is 1.440 (at wavelength 633 nm), and the width of the trench portion 120 is 3 μm. In this case, the numerical aperture NA(0.5 m) at measurement length 0.5 m is 0.220, and the numerical aperture NA(500 m) at measurement length 500 m is 0.202. Further, the value of numerical aperture (1a) is 0.204, and the value of numerical aperture (1b) is 0.252, so that a multi-mode optical fiber having such a structure satisfies both the above conditions (2a) and (2b), as indicated below.

NA(500 m)=0.202≦\sqrt{n1²−n3²}=0.204

\sqrt{n1²−n3²}=0.204≦NA(2 m)=0.220≦\sqrt{n1²−n2²}=0.252

In this way, by means of the multi-mode optical fiber 100 according to the present embodiment, the light receiving-side numerical aperture can be kept lower than the numerical aperture on the light source side.

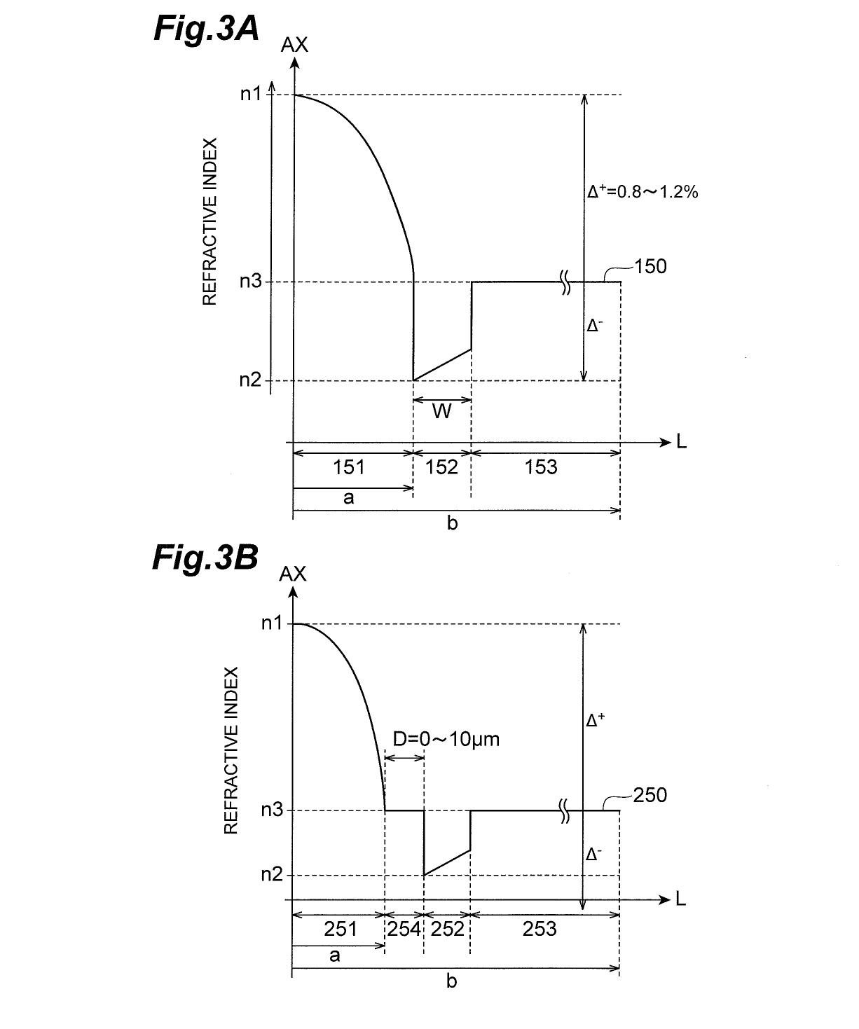

In greater detail, the refractive index profile in the vicinity of the trench portion 120 has a shape such as those shown in FIG. 3A and FIG. 3B. That is, FIG. 3A shows in greater detail the portion of the refractive index profile of FIG. 1B corresponding to the vicinity of the trench portion, and FIG. 3B shows in greater detail, as a modified example of the refractive index profile which can be applied to a multi-mode optical fiber according to the present invention, the portion of the refractive index profile in the modified example corresponding to the vicinity of the trench portion.

In the refractive index profile 150 shown in FIG. 3A, the region 151 corresponding to the core portion 110 has an α-profile shape such that the refractive index is maximum at the center of the core portion 110 coinciding with the optical axis AX; the a value defining this shape is from 1.9 to 2.2. The maximum relative refractive index difference Δ⁺ of the core portion 110 with respect to the cladding portion 130 is 0.8 to 1.2%, and the diameter 2a of the core portion 110 is 47.5 to 52.5 μm. It is preferable that the width W of the region 152 corresponding to the trench portion 120 be 5 μm or less, but the value may be 10 μm or less depending on the structure of the refractive index profile. Further, the refractive index profile of the region 152 corresponding to the trench portion 120 has a shape which increases from the region 151 toward the region 153 (the region corresponding to the cladding portion 130) along the radial direction of the multi-mode optical fiber 100. The minimum relative refractive index difference Δ⁻ of the trench portion 120 with respect to the cladding portion 130 is from −0.8 to -0.4%. Further, the difference between the maximum relative refractive index difference of the core portion 110 and the minimum relative refractive index difference of the trench portion 120, with the cladding portion 130 as reference (=Δ⁺−Δ⁻), is 1.6% or less.

On the other hand, the refractive index profile 250 shown in FIG. 3B comprises a region 251 corresponding to the core portion 110, a region 252 corresponding to the trench portion 120, and a region 253 corresponding to the cladding portion 130, and in addition is provided with a buffer region 254 between the region 251 and the trench portion 252. The width of this buffer region 254 (that is, the interval D between the core portion 110 and the trench portion 120) is from 0 to 10 μm. In a structure in which a buffer region is provided in this way between the core portion 110 and the trench portion 120, the minimum relative refractive index difference Δ⁻ of the trench portion 120 with respect to the cladding portion 130 may be −0.1% or less. By means of a structure provided with such a buffer region, a sufficient light confinement effect can be anticipated.

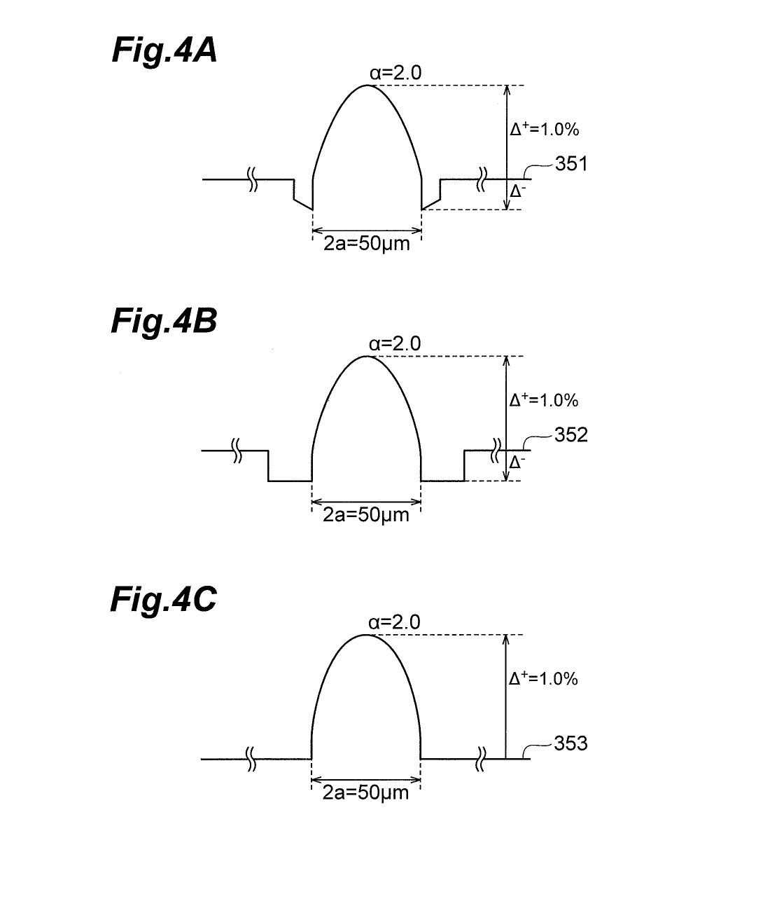

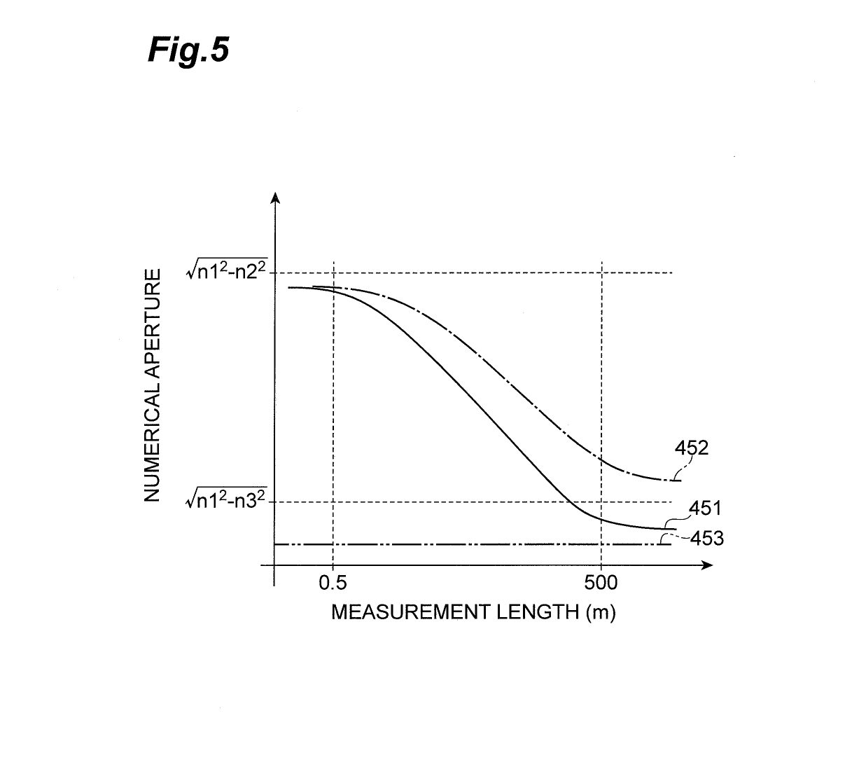

Next, multi-mode optical fibers having various refractive index profiles were prepared by the inventor, and the relation between the measurement length (m) and the numerical aperture was measured. As a result, the results shown in FIG. 5 were obtained. The multi-mode optical fibers prepared were multi-mode optical fibers having the refractive index profiles shown in FIG. 4A to FIG. 4C. That is, FIG. 4A is the refractive index profile according to Embodiment 1, prepared in order to measure the relation between measurement length and numerical aperture; FIG. 4B is the refractive index profile of the multi-mode optical fiber according to Embodiment 2; and FIG. 4C is the refractive index profile of the multi-mode optical fiber according to Embodiment 3.

As shown in FIG. 4A, the refractive index profile 351 of the multi-mode optical fiber according to Embodiment 1 comprises regions corresponding to each of the core portion 110, trench portion 120, and cladding portion 130. The a value defining the α-profile shape of the refractive index profile of the core portion 110 is 2, and the diameter 2a of the core portion 110 is 50 μm. The refractive index profile of the trench portion 120 has a shape which increases from the core portion 110 toward the cladding portion 130 along the radial direction of the multi-mode optical fiber according to Embodiment 1. The maximum relative refractive index difference Δ⁺ of the core portion 110 with the cladding portion 130 as reference is 1.0%. The minimum relative refractive index difference Δ⁻ of the trench portion 120 is adjusted such that the difference between the maximum relative refractive index difference Δ⁺ of the core portion 110 and the minimum relative refractive index difference Δ⁻ of the trench portion 120 is 1.6% or less.

Graph 451 in FIG. 5 represents the relation between numerical aperture and measurement length for the multi-mode optical fiber according to Embodiment 1, having the above-described refractive index profile 351. As can be seen from FIG. 5, in the multi-mode optical fiber according to Embodiment 1, the numerical aperture NA(0.5 m) at measurement wavelength 0.5 m is within the range from the above equation (1a) to the above equation (1b), while the numerical aperture NA(500m) at measurement length 500 m is below the above equation (1a). That is, the multi-mode optical fiber according to Embodiment 1 is a multi-mode optical fiber which satisfies both the above condition (2a) and the above condition (2b).

Through application of the multi-mode optical fiber according to Embodiment 1, both the coupling efficiency with a VCSEL (Vertical-Cavity Surface-Emitting Laser) or other light source, and the coupling efficiency with a PD (Photo Diode) which is a light receiver, are improved. As a result, there are the advantageous results that there is no longer a need to increase the light source emission intensity, and that the amount of power and the amount of heat generation, which is a problem for data centers and similar, can be effectively suppressed.

On the other hand, as shown in FIG. 4B, the refractive index profile 352 of the multi-mode optical fiber according to Embodiment 2 comprises regions corresponding to each of the core portion 110, trench portion 120 and cladding portion 130, similarly to Embodiment 1; in addition, however, there are differences with Embodiment 1 in the shape and width of the refractive index profile in the trench portion 120. That is, the a value defining the α-profile shape of the refractive index profile of the core portion 110 is 2, the diameter 2a of the core portion 110 is 50 μm, and the width W of the trench portion 120 is set to approximately twice that in Embodiment 1. The refractive index profile of the trench portion 120 has a flat shape from the core portion 110 toward the cladding portion 130 along the radial direction of the multi-mode optical fiber according to Embodiment 2. The maximum relative refractive index difference Δ⁺ of the core portion 110 with the cladding portion 130 as reference is 1.0%. The minimum relative refractive index difference Δ⁻ of the trench portion 120 is adjusted such that the difference between the maximum relative refractive index difference Δ⁺ of the core portion 110 and the minimum relative refractive index difference Δ⁻ of the trench portion 120 is 1.6% or less.

Graph 452 in FIG. 5 represents the relation between numerical aperture and measurement length for the multi-mode optical fiber according to Embodiment 2 having the above-described refractive index profile 352. As can be seen from FIG. 5, in the multi-mode optical fiber according to Embodiment 2, the numerical aperture NA(0.5 m) at measurement length 0.5 m is in the range from the above equation (1a) to the above equation (1b). However, the numerical aperture NA(500 m) at measurement length 500 m exceeds the above equation (1a).

When the above condition (2a) is not satisfied, among light emitted from the multi-mode optical fiber with the large numerical aperture, light not entering the PD increases (the coupling efficiency with the PD worsens), which causes inadequate light intensity and thereby increases the possibility of impeding communications. Further, in order to resolve faults on the light-receiving side, if the light amount on the side of the VCSEL or other light source is increased, the problems of increased power amount and heat amount of the light source itself are increased.

Further, as shown in FIG. 4C, the refractive index profile 353 of the multi-mode optical fiber according to Embodiment 3 comprises regions corresponding to each of the core portion 110 and cladding portion 130 (a trench portion 120 does not exist). The a value defining the α-profile shape of the refractive index profile of the core portion 110 is 2,and the diameter 2a of the core portion 110 is 50 μm. The maximum relative refractive index difference Δ⁺ of the core portion 110 with the cladding portion 130 as reference is 1.0%.

Graph 453 in FIG. 5 represents the relation between numerical aperture and measurement length for the multi-mode optical fiber according to Embodiment 3, having the above-described refractive index profile 353. As can be seen from FIG. 5, the numerical aperture of the multi-mode optical fiber according to Embodiment 3 is less than the above equation (1b) over the entire range of measurement lengths from 0.5 to 500 m. That is, the multi-mode optical fiber according to Embodiment 3 satisfies the above condition (2a), but does not satisfy the above condition (2b).

Because multi-mode optical fibers are also often used over short hauls of several meters, if the numerical aperture NA(0.5 m) at measurement length 0.5 m is below the above equation (1a), as in the case of the multi-mode optical fiber according to Embodiment 3, there is an increased possibility that the coupling efficiency with a VCSEL or other light source is worsened.

As a result of these studies, it is found that the multi-mode optical fibers according to Embodiment 1 among the Embodiments 1 to 3 can be applied to a multi-mode optical fiber according to the present invention.

As described above, a multi-mode optical fiber according to the present invention is designed such that the numerical aperture thereof is reduced as the fiber length (measurement length) increases, and moreover is designed such that the maximum value of the slope of the numerical aperture with respect to the measurement length is at a measurement length of 0.5 m or greater and 500 m or less. Further, the numerical aperture at length 500 m satisfies equation (2a). As a result, the numerical aperture at the emission end of the multi-mode optical fiber having a length for which practical use is assumed is kept small, and the coupling efficiency with a light receiver can be increased.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

1. A multi-mode optical fiber which comprises: a core portion extending along a predetermined axis and doped with GeO₂, a trench portion provided on an outer periphery of the core portion and having a refractive index lower than that of the core portion; and a cladding portion provided on an outer periphery of the trench portion and having a refractive index lower than that of the core portion but higher than that of the trench portion,
wherein, in a refractive index profile of the multi-mode optical fiber along a radial direction thereof, an a value of a portion corresponding to the core portion is 1.9 to 2.2, a maximum relative refractive index difference A of the core portion with respect to the cladding portion is 0.8 to 1.2%, a diameter 2a of the core portion is 47.5 to 52.2 μm, and a difference between the maximum relative refractive index difference of the core portion and a minimum relative refractive index difference of the trench portion, with respect to a reference region in the cladding portion, is 1.6% or lower,
wherein a graph representing a relation between a numerical aperture and a length of the multi-mode optical fiber has a shape in which an absolute value of the slope of the graph has a maximum at a length between 0.5 and 500 m, and
wherein, when the maximum refractive index of the core portion is n1, the minimum refractive index of the trench portion is n2, and the refractive index of the cladding portion is n3, then the numerical aperture NA(500 m) at length 500 m of the multi-mode optical fiber satisfies the following condition:
NA(500 m)≦\sqrt{n1²−n3²}.

2. The multi-mode optical fiber according to claim 1, wherein the refractive index of the trench portion increases from the core portion toward the cladding portion along the radial direction of the multi-mode optical fiber.

3. The multi-mode optical fiber according to claim 1, wherein the core portion and the trench portion are separated by from 0 to 10 μm.

4. The multi-mode optical fiber according to claim 1, wherein a width of the trench portion along the radial direction is 10 μm or less.

5. The multi-mode optical fiber according to claim 4, wherein the width of the trench portion along the radial direction is 5 μm or less.

6. The multi-mode optical fiber according to claim 1, wherein the numerical aperture NA(0.5 m) at length 0.5 m of the multi-mode optical fiber satisfies the following condition:
\sqrt{n1²−n3²}≦NA(0.5 m)≦\sqrt{n1²−n2²}.
